(19) United States
(12) Patent Application Publication
(10) Pub. No.: US 2025/0018404 A1
(43) Pub. Date: Jan. 16, 2025

(54) SLURRY FEEDING ARRANGEMENT

(71) Applicant: METSO FINLAND OY, ESPOO (FI)

(72) Inventors: Marly de Avila Carvalho, Helsinki (FI); Ian Michael Sherrell, Columbia, MD (US); Enkhzul Bayarmagnai, Pori (FI)

(73) Assignee: METSO FINLAND OY, ESPOO (FI)

(21) Appl. No.: 18/352,375

(22) Filed: Jul. 14, 2023

(51) Int. Cl. B03D 1/14

(52) U.S. Cl. CPC B03D 1/1456; B03D 1/1493

(57) ABSTRACT

A slurry feeding arrangement, flotation cell, line, and a method for treating particles suspended in slurry. The slurry feeding arrangement comprises one or more slurry feed means configured to feed slurry to a froth layer; a feed chamber configured to receive the fed slurry from the one or more slurry feed means; an overflow ramp between the feed chamber and the froth layer configured to lead the slurry from the feed chamber to the froth layer.

### FIELD OF TECHNOLOGY

This disclosure concerns mineral processing. In particular, this disclosure concerns slurry distribution in tanks used in minerals processing plant.

### BACKGROUND

There are several ways to feed slurry into tank used in minerals processing plant. However, slurry feeding arrangements may further be developed to achieve better mineral separation.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. The scope of protection sought for various embodiments of the present disclosure is set out by the independent claims.

Example embodiments of the present disclosure provide a flotation cell for treating particles suspended in slurry and for separating the slurry into underflow and overflow. The system may relate to a gravity feeding flotation (FID) system in which the slurry is fed into the flotation cell at a froth layer. That is, it is fed on top of the froth layer, into the froth layer, into the slurry froth interface, and/or immediately below the froth layer. The fed slurry may first enter to a feed chamber, for example a dead bed chamber, prior to its entry into a main flotation chamber, such as a tank. The feed chamber may be used to reduce kinetic energy of the fed slurry, such as velocity, and minimize wear on fixed parts. The feed chamber may operate at ambient or atmospheric pressure and may receive the fed slurry from one or more slurry feed means at ambient pressure. The feed chamber may act as an intermediate chamber that may dampen the fed slurry velocity and may allow gradual, evenly distributed overflow from the feed chamber into the tank. Gas bubbles may be added to the fed slurry before the fed slurry enters to the froth layer of the tank. When adding gas bubbles into the fed slurry, the weight of the fed slurry may not increase, but only volume of the fed slurry may increase, and density may decrease. This may help mixing and may generate pre aeration state to the fed slurry before it may enter to the froth layer. This may minimize breakage in the froth phase and may help to keep particles in the froth.

According to a first aspect, a slurry feeding arrangement is disclosed, wherein the slurry feeding arrangement is configured to feed slurry to a froth layer, the slurry feeding arrangement comprises one or more slurry feed means configured to feed the slurry; a feed chamber configured to receive the fed slurry from the one or more slurry feed means; and an overflow ramp between the feed chamber and the froth layer configured to lead the fed slurry from the feed chamber to the froth layer. The implementation of the example arrangement may lead to increased recovery of all hydrophobic particles, especially larger particles. The slurry feeding arrangement may be static and the fed slurry may flow by gravity until it may reach the froth layer. Thus, it may enable even distribution of the slurry on and/or in the froth layer in the flotation cell, thus promoting efficient separation of coarse particles. The feed chamber of the slurry feeding arrangement may have three functions. Firstly, it may break the slurry velocity. Secondly, it may create a dead bed with settled particles that may protect the area against wear. Thirdly, the feeding device may distribute the slurry evenly by overflowing it on top of the overflow ramp. The slurry may flow down along the overflow ramp and may form a constant slurry layer with enough velocity to prevent sanding of the particles. The overflow ramp may direct the slurry flow as horizontally as possible on/in the froth layer. Thus, vertical velocity of the feed entering the froth layer may be minimized. The froth flotation cell according to the invention may enables the recovery of coarse particles in an energy and water efficient manner. Moreover, the slurry feeding arrangement may be used in flotation cells of any shape and size.

According to an example embodiment of the first aspect, the slurry feeding arrangement may comprise a feed means connector connectable to the one or more slurry feed means, wherein the feed chamber may be placed under the feed connector and arranged to receive the fed slurry from the one or more slurry feed means. The one or more slurry feed means may feed the slurry by any means, for example, by gravity or pumping.

According to an example embodiment of the first aspect, the feed means connector may comprise a top plate having one or more feed openings, through which the fed slurry may be arranged to enter the feed chamber and/or compartments.

According to an example embodiment of the first aspect, the feed chamber may comprise a feed chamber bottom and a slurry overflow lip located above the feed chamber bottom; and an overflow ramp extending obliquely downwards from the slurry overflow lip, wherein the fed slurry is configured to flow from the feed chamber over the slurry overflow lip onto the overflow ramp during operation of the slurry feeding arrangement.

According to an example embodiment of the first aspect, wherein the feed chamber may be ring-shaped, and the slurry overflow lip may be arranged on the perimeter of the feed chamber.

According to an example embodiment of the first aspect, the feed chamber may be divided into separate compartments by one or more partition walls.

According to an embodiment of the first aspect, the slurry feeding ramp may be arranged at an angle of 10 to 60 degrees to the horizontal.

According to an embodiment of the first aspect, the slurry overflow lip may be ring-shaped, and the slurry feeding ramp may encircle the slurry overflow lip.

According to an embodiment of the first aspect, the slurry feeding arrangement may comprise feeding strips extending from the lower edge of the overflow ramp and arranged at a distance from each other in the direction of the lower edge.

According to an embodiment of the first aspect, ends of the feeding strips may be connected to the lower edge of the feeding ramp, and the feeding strips may taper towards their second ends.

According to an embodiment of the first aspect, the feeding strips may be triangular in shape.

According to an embodiment of the first aspect, the feeding arrangement may comprise one or more downward sloping guiding plates placed under the lower edge of the overflow ramp and/or the feeding strips. The one or more guiding plates may be configured to direct slurry discharged from the overflow ramp towards a froth overflow lip of a tank, for example, a flotation tank.

According to an example embodiment of the first aspect, the feed chamber may be configured to operate in atmospheric pressure. When the feed chamber is operating in the atmospheric pressure, the fed slurry may not need to be pressurized and thus, the fed slurry may flow gently to the froth layer in the tank.

According to an example embodiment of the first aspect, the slurry feeding arrangement may further comprise at least one gas bubble arrangement configured to feed gas bubbles into the feed chamber and/or on the overflow ramp. The slurry feeding arrangement may have the one or more gas bubble arrangements, which may be different and may be located in different places.

According to an example embodiment of the first aspect, the at least one gas bubble arrangement may comprise one or more gas feed means configured to feed gas bubbles into the feed chamber and/or on the overflow ramp. Different size and amounts of gas feed means may allow different amount of the gas bubbles to be fed in different places of the feed chamber and/or on the overflow ramp. The gas feed means may comprise one or more pipes or tubes.

According to an example embodiment of the first aspect, the one or more gas feed means may be configured to feed gas bubbles inside the feed chamber through the top plate, feed chamber bottom, and/or one or more feed chamber sidewalls. When the one or more gas feed means enter the feed chamber through the top plate, it may maximize mixing of the particles and bubbles and minimizes bypass. Part of the particles may set on the bottom of the feed chamber to protect the bottom from wear. It may also reduce wear on the feed chamber side(s). However, other arrangements may also be used.

According to an example embodiment of the first aspect, the at least one gas bubble arrangement may be configured to feed gas bubbles on the overflow ramp, wherein the one or more gas feed means may be arranged to provide the gas bubbles over the width of the overflow ramp perpendicular to flow of the slurry. The gas bubble arrangement may have one or more outlets or nozzles arranged in a row to feed the gas bubbles out from one or more gas feed means. When the one or more gas feed means are arranged this way, it may increase gas bubble-particle attachment.

According to an example embodiment of the first aspect, the overflow ramp may comprise a ramp bottom, wherein the gas bubble arrangement may be configured to feed gas bubbles on the overflow ramp at a distance, db, from the lower edge of the overflow ramp. The one or more gas feed means may be arranged at a ramp bottom. When the one or more gas feed means outlets or nozzles are arranged at a ramp bottom at a distance, db, from the lower edge of the overflow ramp, the bubble-particle attachment may be done just before the slurry enters the tank which may lead to increased mineral recovery. Also particles may have an opportunity to attach to the bubbles just before they enter the tank which may help them to remain in contact with the gas bubbles before they enter in the froth layer.

According to an example embodiment of the first aspect, the ramp bottom may have at least one of the following form: a curved, stepped, and/or corrugated. The form of the ramp bottom may decrease slurry velocity. In the bottom of the ramp a curve may further decreases the kinetic energy and/or velocity of the feed slurry before it enters the stripes and/or a weir.

According to an example embodiment of the first aspect, each of the one or more gas feed means may comprise one or more nozzles or outlets. The one or more nozzles or outlets may direct flow of the gas bubbles.

According to an example embodiment of the first aspect, the overflow ramp may comprise a ramp surface, which may comprise a ramp bottom and a weir, wherein the ramp surface may be arranged towards the froth layer; may be configured to slope towards the froth layer and downwards towards the ramp bottom; and may be configured to rise up from the ramp bottom towards the weir. A form of the ramp may reduce velocity of the feed stream entering the froth layer in the main flotation tank, which may reduce turbulence in the froth layer and froth breakage.

According to an example embodiment of the first aspect, the slurry feeding arrangement may comprises 1 to 512 slurry feed means.

According to a second aspect, a flotation cell for treating particles suspended in slurry is disclosed, wherein the flotation cell comprises a tank for holding a volume of slurry and a froth layer over the volume of slurry; and a slurry feeding arrangement according to any of the first aspects. By mixing gas bubbles with the slurry upstream of the flotation tank has an effect that some bubble-particle attachment may be achieved before the fed slurry enters the main flotation tank. This may lead to an increased recovery because there may be some particle recovery in the slurry feeding arrangement in addition to recovery in the main flotation tank. Main bubble particle contact may, however, take place in the tank. Coarse particles in the fed slurry may have an opportunity to attach to bubbles before they enter the main flotation tank. They may then already be attached to the bubbles when they enter the froth layer in the tank and may more likely remain in the froth layer and be floated off. In conventional cells, when coarse particles enter the main chamber, they may be prone to sinking and may have difficulties to float. The velocity of the feed stream entering the froth layer in the main flotation chamber may be reduced by addition of gas in the slurry feeding arrangement. Furthermore, a slurry stream with gas bubbles may have a lower specific gravity and thus may carry less energy when it flows into the froth layer and mixes with the froth layer. This may reduce turbulence in the froth layer and froth breakage which may be crucial for high rates of recovery. The implementation of the example arrangement and method may lead to increased recovery of all hydrophobic particles, especially larger particles.

According to an example embodiment of the second aspect, the flotation cell may be a gravity feeding flotation cell. In a gravity feeding system, the slurry may be fed into the flotation tank at the froth layer. When the slurry is fed by gravity, the fed slurry may not need to be pressurized and thus, the fed slurry need not to be pumped in to the cell at high pressure. Instead, the fed slurry may flow gently to the froth layer in the tank. However, also pumping means may be used to feed slurry.

According to an example embodiment, in a conventional gravity fed type of flotation cell, gas for producing the gas bubbles for flotation may be added through a gasified fluid generator in the main flotation tank. That is, the feed slurry that may enter the feed chamber and then may flow onto the overflow ramp, and from there to the froth layer, may not have any added gas. The gas may be added in the main flotation tank below the froth layer, wherefrom it may rise up to the froth layer and may adhere to fine and/or coarse particles of the slurry.

According to an example embodiment of the second aspect, the feed chamber may have an annular or circular shape, and it may be arranged concentric to a tank side wall. It may be located around a central axis. The feed chamber may be arranged at a distance from a center axis of the flotation tank. The location and shape of the feed chamber may allow placing it straight below the one or more slurry feed means. According to an example embodiment of the second aspect, the slurry feeding arrangement may comprises 1 to 512 slurry feed means. The slurry feed means may be a tube or pipe. The slurry feeding arrangement may comprises 2 to 400 slurry feed means, preferably 4 to 240 slurry feed means. The exact number of slurry feed means within a flotation cell may depend on the flotation tank size or volume, or the type of material to be collected and other process parameters. By arranging a sufficient number of slurry feed means into the flotation cell, and by arranging them in a specific manner in relation to the flotation tank center and perimeter and/or tank side wall, even distribution of the slurry may be ensured while at the same time ensuring a high probability for collisions between bubbles and ore particles.

According to an example embodiment of the second aspect, the one or more slurry feed means may be arranged concentric to the tank side wall of the flotation cell. The one or more slurry feed means may be arranged concentric to the tank side wall of the flotation cell at a distance from the center axis of the flotation tank. By arranging a sufficient number of slurry feed means into the flotation cell in a specific manner in relation to the flotation tank center and perimeter and/or tank side wall, even distribution of the slurry may be ensured while at the same time ensuring a high probability for collisions between bubbles and particles.

According to an example embodiment of the second aspect, the one or more slurry feed means may be arranged above the froth layer. By arranging the one or more slurry feed means above the froth layer may allow utilization of gravity feed system or other systems wherein the slurry is feed above or below the froth layer, and/or from the side wall of the tank.

According to an example embodiment of the second aspect, the slurry feeding arrangement may be configured to feed slurry onto the froth layer, into the froth layer, into the froth slurry interface, and/or immediately below the froth layer. The froth slurry interface may mean a layer on top of the slurry inside the flotation tank. In the froth slurry interface gas hold-up percentage may be between 10-50. Different methods and systems may be used to feed the slurry in the different parts of the froth layer. A place of the slurry feeding arrangement may also depend on rheology of the slurry and/or the gas bubbles to be fed into the slurry.

According to an example embodiment of the second aspect, the flotation cell may further comprise a launder with a launder lip for collecting froth from the froth layer. The tank comprising a launder may facilitate collection of a flotation product from said tank.

According to an example embodiment of the second aspect, the flotation cell may further comprise one or more froth crowders arranged to direct froth towards a launder. The crowder may be utilized to direct or guide the upwards-flowing slurry and/or gasified fluid within the flotation tank closer to a froth overflow lip of a froth collection launder, thereby enabling or easing froth formation very close to the froth overflow lip, which may increase the collection of valuable ore particles.

According to an example embodiment of the second aspect, the flotation cell may comprise a flotation gas supply arrangement for supplying flotation gas into the slurry below the slurry feeding arrangement. The flotation gas supply arrangement may allow the froth layer to be maintained over the slurry.

According to an example embodiment of the second aspect, the flotation cell may comprise a flotation liquid supply arrangement for supplying flotation liquid into the volume of slurry below the slurry feeding arrangement.

It is to be understood that the example embodiments of the first and second aspect described above may be used in any combination with each other. Several of the example embodiments may be combined together to form a further embodiment.

According to a third aspect, a flotation line comprising one or more flotation cells is disclosed, wherein at least one of the flotation cells is a flotation cell according to any of the second aspects. Particle recovery may be improved by increasing the number of flotation cells within a flotation line, or by recirculating the once-floated material (overflow) or the tailings flow (underflow) back into the beginning of the flotation line, or to precedent flotation cells.

According to a fourth aspect, a method for treating particles suspended in slurry in a flotation cell according to the second aspect or any embodiment of the second aspect, wherein the method comprises providing a tank for holding a volume of slurry and a froth layer over the volume of slurry; feeding, by a slurry feeding arrangement comprising one or more slurry feed means, the slurry to a feed chamber; receiving, by the feed chamber, the fed slurry from the one or more slurry feed means; leading the fed slurry, by an overflow ramp between the feed chamber and the tank, from the feed chamber to the froth layer; and feeding gas bubbles, by one or more gas bubble arrangements, to the fed slurry before the fed slurry enters to the froth layer. By mixing gas bubbles with the fed slurry upstream of the flotation tank may have an effect that some bubble-particle attachment may be achieved before the fed slurry enters the main flotation tank. This may lead to an increased recovery because there may be some particle recovery in the fed slurry feeding arrangement in addition to recovery in the main flotation tank.

### BRIEF DESCRIPTION OF THE DRAWINGS

The present disclosure will be better understood from the following detailed description read in light of the accompanying drawings, wherein:

FIG. 1 shows schematically an example of a flotation cell with a slurry feeding arrangement,

FIG. 2 shows schematically an example of a gas bubble arrangement configured to feed gas bubbles into a feed chamber,

FIG. 3 shows schematically another example of a gas bubble arrangement configured to feed gas bubbles on the overflow ramp,

FIG. 4 shows schematically still another example of a gas bubble arrangement configured to feed gas bubbles on the overflow ramp, and

FIG. 5 shows an example method for treating particles suspended in slurry and for separating the slurry into underflow and overflow using a flotation cell.

Unless specifically stated to the contrary, any drawing of the aforementioned drawings may be not drawn to scale such that any element in said drawing may be drawn with inaccurate proportions with respect to other elements in said drawing in order to emphasize certain structural aspects of the embodiment of said drawing.

Moreover, corresponding elements in the embodiments of any drawings of the aforementioned drawings may be disproportionate to each other in said drawings in order to emphasize certain structural aspects of the embodiments of said drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

According to an example embodiment, flotation involves introducing a treated mineral slurry feed containing mineral and rock particles into a flotation cell. A stream of gas bubbles, for example air bubbles, may be introduced into the cell and the desired particles may attach to the gas bubbles and float off the cell. Unwanted gangue particles may sink and may be removed from the bottom of the cell. Flotation may be a successful technology for recovering valuable mineral from streams of broken ore. It may be used to separate a valuable mineral from a waste or gangue rock material.

In a gravity feeding flotation (FID) system the slurry feed may be fed into the flotation tank at a froth layer. That is, it may be fed on top of the froth layer, into the froth layer, into the froth slurry interface, and/or immediately below the froth layer. The slurry feed may first enter a feed chamber, for example a dead bed chamber, prior to its entry into the main flotation tank. The feed chamber may be used to reduce fed slurry energy, such as velocity, and minimize wear on fixed parts. The feed chamber may operate at ambient or atmospheric pressure and may receive the fed slurry from one or more slurry feed means at ambient pressure. The feed chamber may act as an intermediate chamber that may dampen the fed slurry velocity and may allow gradual, evenly distributed overflow from the feed chamber into the main flotation tank.

The main flotation tank may float off the valuable mineral in the froth layer. The main flotation may also have spargers providing a supply of gas bubbles that may rise through the tank. The froth layer may comprise gas bubbles with mineral particles attached to the gas bubbles at a top of the flotation tank. The froth layer may gently overflow into a circumferential channel which may take gathered mineral on the bubbles with it. The condition of the froth layer may be crucial to the recovery achieved in the flotation cell. The froth layer may be fragile and may need to be handled gently. In particular, the froth layer may not be exposed to high shear forces that may break down the froth or damage it in some way.

The flotation cell may utilize a gravity feed arrangement in an upstream of the flotation tank. The gravity feed arrangement may include a feed chamber, one or more slurry feed means upstream of the feed chamber, and an overflow ramp between the feed chamber and the flotation tank. The feed chamber may receive gravity fed slurry through the one or more slurry feed means for example, from above. The feed chamber may be at atmospheric pressure and may be used to reduce kinetic energy in the fed slurry before it enters into the flotation tank. The feed chamber may gently and evenly discharge the feed slurry into the flotation tank via the overflow ramp. The slurry feed may flow into an upper region of the flotation tank where the froth layer is located.

In the gravity feed flotation cell, the feed slurry may be introduced into the main flotation tank at the level of the froth layer because the feed slurry is at atmospheric pressure.

According to an example embodiment, in a conventional gravity feed flotation cell, air for producing bubbles for flotation is added below the froth layer through spargers in a main flotation chamber only. This means that feed slurry that may enter a feed chamber, then flow onto an overflow ramp, and from there into a froth layer of the flotation tank, may not have any added air. The air may only be added in the flotation tank. One of the problems with a conventional arrangement may be how to preserve strength and quality in the froth layer that may enable high recovery rates of valuable mineral. The froth may not be subjected to forces that break or damage it. One thing that may damage the froth may be the feed slurry that may flow over the overflow ramp and into the froth layer. The kinetic energy of this overflowing slurry, without any air bubbles, with its high specific gravity and inertia may be prone to damage the froth layer. Even though the feed chamber may reduce the kinetic energy of the feed slurry it may still carry momentum into the flotation tank and this momentum may potentially be harmful to the already established froth layer in the tank. Another problem may be how to achieve effective attachment of heavy mineral particles in the slurry to the bubbles in the tank. These heavy particles may tend to descend rapidly down through the flotation tank after they may enter the flotation tank, and it may be difficult to attach and lift up them with the bubbles once they have already fallen. This may be a reason for reduced recovery of large valuable mineral particles in these cells. Yet another problem may be the challenge of obtaining as much bubble particle contact as possible within the flotation cell. The amount of contact directly may influence the recovery of the flotation cell. In the flotation cells, particle bubble contact may occur in the main flotation tank. There may be no contact of air bubbles with particles in any part of a slurry feeding arrangement of the gravity feed system, which may comprise the feed chamber and the overflow ramp feeding slurry into the froth layer. However, it might be advantageous if greater particle bubble contact could be achieved with a flotation equipment.

According to an example embodiment, gas bubbles, for example air bubbles, is introduced to a feed slurry upstream of the main flotation tank into a slurry feeding arrangement before the slurry enters the flotation tank. It may enhance bubble particle attachment and slow feed velocity of attached particles through an initial feeding zone of froth. This may overcome above mentioned problems relating to the gravity feed flotation systems. By mixing gas bubbles with the slurry upstream of the flotation tank some bubble-particle attachment may be achieved before the slurry enters into the flotation tank. This may lead to an increased recovery because there may be some particle recovery in the slurry feeding arrangement in addition to recovery in the main flotation tank. Coarse particles in the feed slurry may have an opportunity to attach to the gas bubbles before they enter the tank. They may then be already attached to the gas bubbles when they enter the froth layer in the tank and may be more likely to remain in the froth layer and be floated off. The velocity of the feed slurry entering the froth layer in the flotation tank may be reduced by the addition of gas in the slurry feeding arrangement. Furthermore, the slurry stream with the gas bubbles may have a lower specific gravity and thus may carry less energy when it flows into the froth layer and mixes with the froth layer. This may reduce turbulence in the froth layer and froth breakage which may be crucial for high rates of recovery. The implementation of the flotation cell and method may lead to increased recovery of all hydrophobic particles, especially larger particles.

According to an example embodiment, a gas stream is introduced into a feed chamber of a slurry feeding arrangement, where it mixes with a slurry stream. Gas may be added to the feed chamber separately from the slurry feed stream. Particles and gas bubbles may contact each other in the feed chamber. The gas may be introduced into the feed chamber by means of a gas bubble arrangement comprising one or more gas feed means or spargers, which may generate gas bubbles that may contact slurry particles. A preferred position for the one or more gas feed means to enter the feed chamber may be through a top plate. This position may maximize mixing of the particles and gas bubbles and minimizes bypass. It may also reduce wear on a feed chamber bottom. However, the gas may be introduced to the feed chamber through a feed chamber bottom and/or one or more feed chamber sides.

According to an example embodiment, a gas stream is introduced onto an overflow ramp where it mixes with a slurry stream before it flows over the overflow ramp and enters to a froth layer in a flotation tank. Gas may be added to a flow passage downstream of the feed chamber and upstream of the flotation tank. The feed slurry may flow gently from the feed chamber over the overflow ramp into the froth layer of the tank. The overflow ramp may slope gently down from the feed chamber to a ramp bottom and then up to a weir over which the feed slurry may flow into the main chamber. The one or more gas feed means or spargers may be configured to provide gas bubbles to the overflow ramp. The one or more gas feed means may have one or more outlets or spargers, which may extend transverse to the direction of slurry flow across the width of the overflow ramp. The gas bubbles may be introduced into the feed slurry near the ramp bottom where it may mix with the feed slurry before it may enter the flotation tank.

Introducing gas bubbles to a feed in a slurry feeding arrangement may enhance bubble-particle attachment and slow down feed velocity of the feed slurry and the gas bubbles entering a froth layer in a flotation tank.

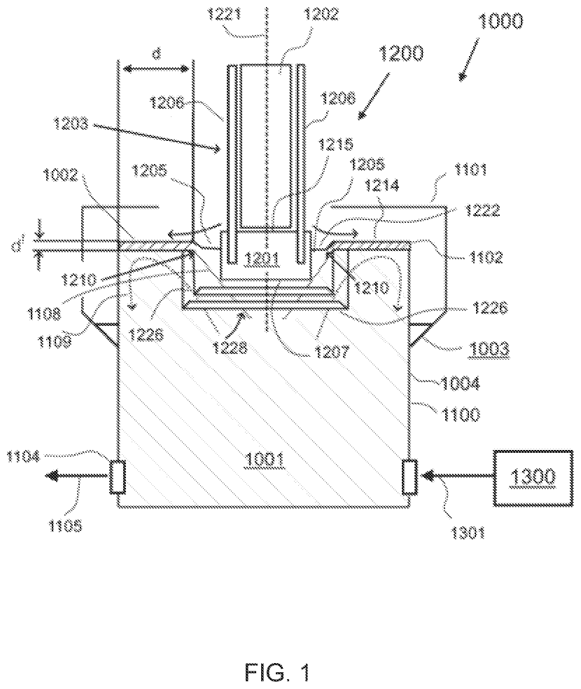

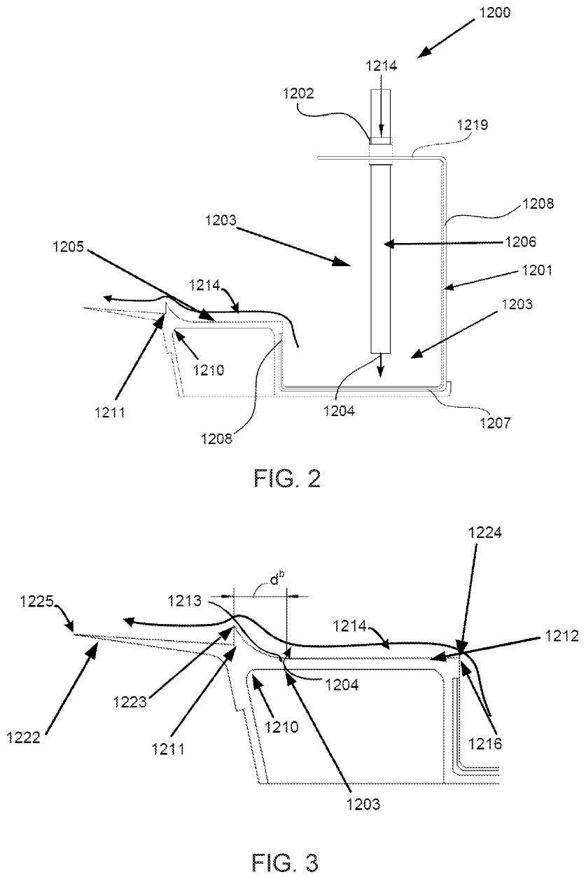

The enclosed FIG. 1 example illustrates a flotation cell 1000 in some detail. FIGS. 2 to 4 illustrate in a schematic manner example embodiments of a slurry feeding arrangement. The figures are not drawn to proportion, and many of the components of the flotation cell 1000 are omitted for clarity.

A flotation cell 1000 according to an example embodiment of FIG. 1 is intended for treating mineral ore particles suspended in feed slurry 1214 and for separating the volume of slurry 1001 into an underflow 1005 and an overflow 1003, the overflow 1003 may comprise a concentrate of a desired mineral.

By overflow herein is meant the part of the slurry collected into the launder of the flotation cell and thus leaving the flotation cell. Overflow may comprise froth, froth and slurry, or in certain cases, only or for the largest part slurry. In some embodiments, overflow may be an accept flow containing the valuable material particles collected from the slurry. In other embodiments, the overflow may be a reject flow. This is the case in when the flotation cell and/or method is utilized in reverse flotation.

By underflow herein is meant the fraction or part of the slurry which is not floated into the surface of the slurry in the flotation process. In some embodiments the underflow may be a reject flow leaving a flotation cell via an outlet which typically is arranged in the lower part of the flotation cell. Eventually the underflow from the final flotation cell of a flotation line or a flotation arrangement may leave the entire arrangement as a tailings flow or final residue of a flotation plant. In some embodiments, the underflow may be an accept flow containing the valuable mineral particles. This is the case in when the flotation cell or flotation line is utilized in reverse flotation.

According to an example embodiment, the flotation cell 1000 comprises a tank 1100 for holding a volume of slurry 1001 and a froth layer 1002 over the volume of slurry 1001, and a slurry feeding arrangement 1200 configured to feed the fed slurry 1214 to the froth layer 1002. The slurry feeding arrangement 1200 may comprise one or more slurry feed means 1202 configured to feed slurry 1214, and a feed chamber 1201 configured to receive the fed slurry 1214 from the one or more slurry feed means 1202. The slurry feeding arrangement 1200 may further comprise an overflow ramp 1205 between the feed chamber 1201 and the tank 1100 configured to lead the slurry 1214 from the feed chamber 1201 to the froth layer 1002, and one or more gas bubble arrangements 1203 configured to feed gas bubbles 1204 to the slurry 1214 before the slurry 1214 enters to the froth layer 1002.

Throughout this specification, “flotation” may refer to separation of a mixture by adhering a substance in said mixture at an interface. In flotation, separation of a mixture may be based on differences in the hydrophobicity of substances in said mixture. Herein, “separation” may refer to the extraction or removal of a substance from a mixture for use or rejection.

Further, “froth flotation” may refer to flotation, wherein froth is utilized for separation. Herein, “froth” may refer to a dispersion, comprising a greater portion by volume of gasified fluid dispersed as gasified fluid in lesser portion by volume of a flotation liquid. Generally, froth may or may not be stabilized by solid particles. In froth, gas bubbles may generally have an average diameter greater than or equal to 1 mm. Additionally or alternatively, an average distance between neighboring gas bubbles in froth not stabilized by solid particles may generally be less than or equal to some tens of micrometers, for example, less than or equal to 50 μm or 30 μm. Naturally, in froth stabilized by solid particles, average distance between neighboring gas bubbles may be increased in proportion to the average size and quantity of said solid particles.

On the other hand, “flotation liquid” may refer to any liquid substance or mixture suitable for use in flotation. Although in practical applications water or aqueous solutions are often used as flotation liquids, other types of liquid substances may also be utilized, as known to the skilled person.

The term “flotation gas” may refer to any gaseous substance suitable for use in flotation. Although in practical applications air is often used a flotation gas, other types of gaseous substances may also be utilized, as known to the skilled person.

FIG. 1 shows a froth flotation cell 1000 and FIGS. 2 to 4 show a slurry feeding arrangement 1200 according to an embodiment of the invention. The froth flotation cell 1000 comprises a flotation tank 1100, in which the slurry feeding arrangement 1200 is arranged. The slurry feeding arrangement 1200 is configured to feed slurry 1214 directly to the froth layer 1002 formed at the top of the flotation tank 1100 of the flotation cell 1000. The slurry feeding arrangement 1200 is configured to feed the slurry 1214 for interaction with froth layer 1002 above the froth layer 1002, and/or in the froth layer 1002, and/or into the froth slurry interface, and/or under the froth layer 1002 in proximity thereof, e.g., at most two times the froth depth, or at most the froth depth, or at most ½ of the froth depth, or at most 1/5 of the froth depth, or at most 1/10 of the froth depth under said froth layer 1002.

The slurry fed by the slurry feeding arrangement 1200 may contain coarse mineral ore particles.

The slurry feeding arrangement 1200 may comprise a feed means connector 1215, which may be connectable to the slurry feed means 1202 of the flotation cell 1000.

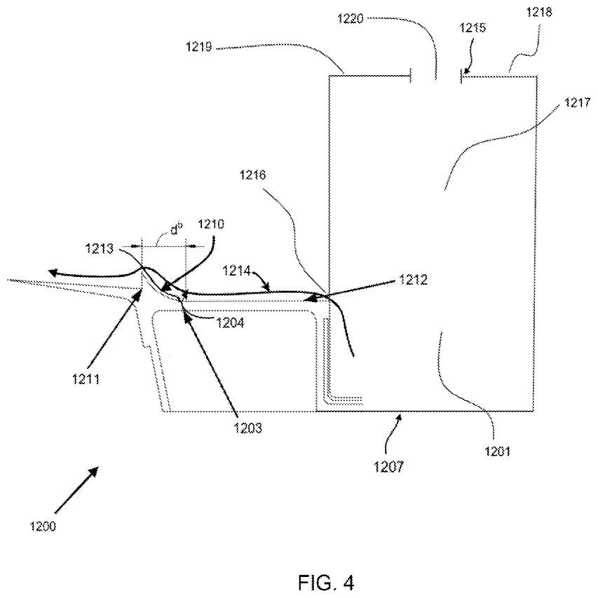

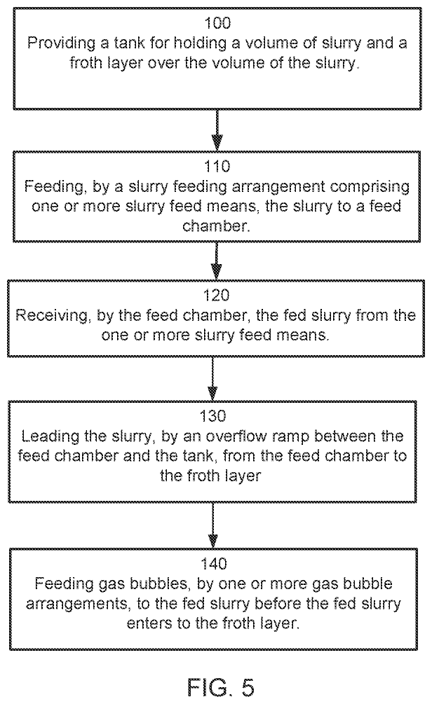

The slurry feeding arrangement 1200 may further comprise a feed chamber 1201 placed under the feed means connector 1215. The feed chamber 1201 may be arranged to receive the feed slurry 1214 from feed means connector 1215 during the operation of the slurry feeding arrangement 1200. The feed chamber 1201 may be circular, rectangular, or ring-shaped. An example of FIG. 4 shows that the feed chamber 1201 comprises one or more partition walls 1218 by which the feed chamber 1201 is divided into separate compartments 1217. The feed chamber 1201 may comprise 3 to 30 compartments 1217. The feed chamber 1201 may be attached to the feed means connector 1215.

The feed chamber 1201 may comprise a feed chamber bottom 6 and a slurry overflow lip 1216 located above the feed chamber bottom 6. The slurry overflow lip 1216 may be arranged on the perimeter of the feed chamber 1201. The slurry overflow lip 1216 may be ring-shaped. The slurry overflow lip 1216 may form the outer edge of the feed chamber 1201/each compartment 1217.

The feed means connector 1215 may comprise a top plate 1219 having feed openings 1220 through which the slurry 1214 may be arranged to enter the feed chamber 1201 and/or compartments 1217. The top plate 1219 may comprise one or more feed openings 11220 for each compartment 1217. The feed chamber 1201 may be attached to the top plate 1219, e.g., the lower surface of the top plate 1219.

The slurry feeding arrangement 1200 may further comprise an overflow ramp 1205 extending obliquely downwards from the slurry overflow lip 1216. The overflow ramp 1205 may comprise an inclined plate that extends obliquely downwards from the slurry overflow lip 1216. The slurry 1214 may be configured to flow from the feed chamber 1201/compartments 1217 over the slurry overflow lip 1216 onto the overflow ramp 1205, and downward along the overflow ramp 1205 during operation of the slurry feeding arrangement. The overflow ramp 1205 may comprise an upper edge 1224 connected to the slurry overflow lip 1216 and a lower edge 1223. The overflow ramp 1205 may be arranged at an angle of 10 to 60 degrees to the horizontal. The overflow ramp 1205 may encircle the slurry overflow lip 1216. The overflow ramp 1205 may have a shape of a truncated cone.

The slurry feeding arrangement may further comprise feeding strips 1222 extending from the lower edge 1223 of the overflow ramp 1205. The feeding strips 1223 may be arranged at a distance from each other in the direction of the lower edge 1223 so that the fed slurry 1214 discharged from the overflow ramp 1205 may flow along and between the feeding strips 1222 to the froth layer 1002. The ends of the feeding strips 1222 may be connected to the lower edge 1223 of the overflow ramp 1205. The feeding strips 1222 may taper towards their second ends 1225. The feeding strips 1222 may be triangular in shape. The feeding strips 1222 may extend horizontally or obliquely downward from the lower edge 1223 of the overflow ramp 1205. The feeding strips 1222 may increase the slurry feeding capacity of the slurry feeding arrangement 1200 and promote more even distribution of the slurry 1214 into the froth layer 1002.

The feeding arrangement 1200 may further comprise one or more downward sloping guiding plates 1226 placed under the lower edge 1223 of the feeding ramp 1205 and/or feeding strips 1222. The guiding plates 1226 may be arranged in a stepped manner so that slurry 1214 may flow from the upper guiding plate 1226 onto the lower guiding plate 1226. The guiding plate(s) 1226 may be arranged at an angle of 10 to 60 degrees to the horizontal. The guiding plates 1226 may direct the upward flow of flotation gas bubbles 1204 within the froth layer 1002 towards the launder lip 1102 of the flotation tank 1100, slow down the downward velocity that the slurry flow has after exiting the feeding strips 1222 and thus may increase the residence time of the slurry 1214 in the froth layer 1002.

The froth flotation cell 1000 may be configured to treat coarse mineral ore particles suspended in fed slurry 1214 and separate volume of slurry 1001 into an overflow 1003 and underflow 1105. The flotation cell 1000 may be a mechanically agitated flotation cell or column flotation cell. The flotation cell 1000 may comprise a flotation tank 1100 and a gas supply 1300 for introducing flotation gas 1301 into volume of slurry 1003 in the flotation tank 1100 to form a froth layer 1002 at the top of the flotation tank 1100. The flotation tank 1100 may be circular or rectangular. The flotation cell 1000 may comprise a mixing device, such as rotor-stator type agitator, and the gas supply 1300 may be arranged in connection with the mixing device. Alternatively, the gas supply 1300 may comprise gas inlets, such as spargers, configured to introduce flotation gas 1301 into the flotation tank 1100, as is the case in a column flotation cell.

The flotation tank 1100 may comprise a froth collection launder 1101 having a launder lip 1102 arranged in the upper part of the flotation tank 1100. The launder lip 1102 may surround the perimeter of the flotation tank 1100. During the use of the flotation cell 1000, a froth layer 1002 may be formed at the top of the flotation tank 1100. Froth, which may contain flotation gas bubbles agglomerated with mineral ore particles, may be discharged from the froth layer 1002 over the launder lip 1102 into the froth collection launder 1101, and out of the flotation cell 1000 as overflow 1003.

The flotation tank 1100 may further comprise an underflow outlet 1104 arranged at the bottom or side wall near the bottom of the flotation tank 1100. Tailings or underflow 1105 may be discharged from the flotation tank 1100 through the underflow outlet 1104.

Moreover, the flotation cell 1000 may comprise the slurry feeding arrangement 1200 described above. The feed means connector 1215 of the feeding arrangement 1200 may be connected to the slurry feed means 1202 of the flotation cell 1000. The feeding arrangement 1200 may be arranged above the froth layer 1002 or in the froth layer 1002 during the operation of the flotation cell 1000. The slurry feeding arrangement 1200 may be configured to feed the slurry 1214 above the froth layer 1002, into the froth layer 1002, into the froth slurry interface, and/or under the froth layer 1002 in close proximity thereof during the operation of the flotation cell 1000.

The flotation cell 1000 may be operated as follows. A froth layer 1002 may be formed at the top of the flotation tank 1100 by introducing flotation gas into the volume of slurry 1001 in the flotation tank 1100.

Feed slurry 1214 may be fed from the feed means 1202 into the feeding arrangement 1200. The fed slurry 1214 may drop vertically into the feed chamber 1201. Thereafter, the fed slurry 1214 may flow from the feed chamber 1201 over the slurry overflow lip 1216 onto the overflow ramp 1205, and downward along the overflow ramp 1205. The fed slurry 1214 may exit the feeding strips 1222 and flows along the guiding plate(s) 1226 toward the launder lip 1102.

Hydrophobic particles contained in the slurry feed may adhere to the flotation gas bubbles in the froth layer 1002. The bubble-particle agglomerates may be removed from the flotation tank 1100 over the launder lip 1102 and passed into the froth collection launder 1101 with overflow 1003. Hydrophilic particles may pass through the froth layer 1002 to the volume of slurry 1001 below it and may be discharged from the flotation tank 1100 with underflow 1105.

In examples of FIGS. 2 to 4, the flotation cell 1000 comprises a gas bubble arrangement 1203 for supplying gas bubbles 1204 into the slurry 1214 feed from the one or more slurry feed means 1202. Gas bubbles may be air bubbles, for example.

In this disclosure, a “gas bubble arrangement” may refer to an arrangement of parts of a flotation cell suitable for or configured to supply flotation gas into feed slurry. Generally, a gas bubble arrangement may comprise any part(s) suitable or necessary for supplying flotation gas into feed slurry, for example, one or more spargers, e.g., jetting and/or cavitation sparger(s), and/or one or more static mixers.

Jetting spargers may be utilized for the direct introduction of microbubbles with a size range of 0,5 to 1,2 mm. Cavitation spargers or Venturi spargers may be utilized to introduce water and air or other gasified fluid into the flotation tank and/or to feed slurry. In these embodiments, air/gas or air/gas and water, respectively, will be introduced into the spargers to create gas bubbles, injected into the flotation tank or fed slurry. The gas bubbles may attach to the mineral ore particles and increase the overall recovery of valuable mineral.

In the example embodiment of FIG. 1, air may be used as a flotation gas 1301. In other embodiments, any suitable gas e.g., air, argon, nitrogen, hydrogen, or mixtures thereof, may be used.

In the embodiments of FIGS. 2 to 4, air may be used as the bubble gas. In other embodiments, any suitable flotation gas(es), e.g., air, argon, nitrogen, hydrogen, or mixtures thereof, may be used.

The gas bubble arrangement 1203 of the example embodiments of FIGS. 2 to 4 is configured to supply gas bubbles 1204 into the feed slurry 1214 such that the gas bubbles 1204 are added to the feed slurry 1214.

The gas bubble arrangement 1203 of the example embodiments of FIGS. 2 to 4 is configured to supply gas bubbles 1204 into the feed slurry 1214 after the slurry feeding arrangement 1200. Generally, a gas bubble arrangement being configured in such manner may increase the probability of collection of valuable material containing particles into a froth layer.

The gas bubble arrangement 1203 of the example embodiments of FIGS. 2 to 4 is configured to supply gas bubbles 1204 into the fed slurry 1214 after and/or below the one or more slurry feed means 1202 by feeding gas bubbles 1204 into the fed slurry 1214 via one or more gas feed means 1206.

Throughout this specification, a “cell” may refer to a device suitable for or configured to perform at least one specific process. Naturally, a “flotation cell” may then refer to a cell suitable for or configured to subject material to flotation. A cell may generally comprise one or more parts, and each of the one or more parts may be classified as belonging to an arrangement.

A flotation cell meant for treating mineral ore particles suspended in slurry by flotation. Thus, valuable metal-containing ore particles may be recovered from ore particles suspended in slurry.

According to an example embodiment, a flotation line comprises one or more flotation cells. By flotation line herein is meant a flotation arrangement where a number of flotation cells may be arranged in fluid connection with each other so that the underflow of each preceding flotation cell may be directed to the following or subsequent flotation cell as infeed until the last flotation cell of the flotation line, from which the underflow may be directed out of the line as tailings or reject flow. Slurry may be fed through a feed inlet or slurry feeding arrangement to the first flotation cell of the flotation line for initiating the flotation process. A flotation line may be a part of a larger flotation plant or arrangement containing one or more flotation lines. Therefore, a number of different pre-treatment and post-treatment devices or stages may be in operational connection with the components of the flotation arrangement, as is known to the person skilled in the art.

The flotation cells in a flotation line may be fluidly connected to each other. The fluid connection may be achieved by different lengths of conduits such as pipes or tubes, which may also comprise pumps or regrinding units, the length of the conduit depending on the overall physical construction of the flotation arrangement. In between the flotation cells of a flotation line, pumps or grinding/regrinding units may also be arranged. Alternatively, the flotation cells may be arranged in direct cell connection with each other. By direct cell connection herein is meant an arrangement, whereby the outer walls of any two subsequent flotation cells are connected to each other to allow an outlet of a first flotation cell to be connected to the inlet of the subsequent flotation cell without any separate conduit. A direct contact may reduce the need for piping between two adjacent flotation cells. Thus, it may reduce the need for components during construction of the flotation line, speeding up the process. Further, it might reduce sanding and simplify maintenance of the flotation line. The fluid connections between flotation cells may comprise various regulation mechanisms.

By “neighbouring”, “adjacent”, or “adjoining” flotation cell herein is meant the flotation cell immediately following or preceding any one flotation cell, either downstream or upstream, or either in a rougher flotation line, in a scavenger flotation line, or the relationship between a flotation cell of a rougher flotation line and a flotation cell of a scavenger flotation line into which the underflow from the flotation cell of the rougher flotation line may be directed.

A flotation cell may comprise a tank or vessel in which a step of a flotation process may be performed. A flotation tank may typically be cylindrical in shape, the shape defined by an outer wall or outer walls. The flotation tanks regularly may have a circular cross-section. The flotation tank may have a polygonal, such as rectangular, square, triangular, hexagonal or pentagonal, or otherwise radially symmetrical cross-section, as well. The number of flotation cells may vary according to a specific flotation line and/or operation for treating a specific type and/or grade of ore, as is known to a person skilled in the art.

A slurry feed arrangement may comprise a feed chamber into which fed slurry flows. A feed chamber may typically be cylindrical in shape, the shape defined by an outer wall or outer walls. The feed chamber regularly may have a circular or ring-shaped cross-section. The feed chamber may have a polygonal, such as rectangular, square, triangular, hexagonal or pentagonal, or otherwise radially symmetrical cross-section, as well. The fed slurry may be fed from a side wall towards the opposite side wall, for example when the feed chamber has a rectangular form.

The flotation cell may be a froth flotation cell, such as a mechanically agitated cell, for example a TankCell, a column flotation cell, a Jameson cell, a gravity feed flotation cell, or a dual flotation cell. In a dual flotation cell, the cell may comprise at least two separate vessels, a first mechanically agitated pressure vessel with a mixer and a gasified fluid input, and a second vessel with a tailings output and an overflow froth discharge, arranged to receive the agitated slurry from the first vessel. The flotation cell may also be a fluidized bed flotation cell (such as a HydroFloatTM cell), wherein air or other gasified fluid bubbles which are dispersed by the fluidization system percolate through the hindered-setting zone and attach to the hydrophobic component altering its density and rendering it sufficiently buoyant to float and be recovered. In a fluidized bed flotation cell axial mixing may not be needed. The flotation cell may also be an overflow flotation cell operated with constant slurry overflow. In an overflow flotation cell, the slurry is treated by introducing gas bubbles into the slurry and by creating a continuous upwards flow of slurry in the vertical direction of the first flotation cell. At least part of the valuable metal containing ore particles may be adhered to the gas bubbles and rise upwards by buoyancy, at least part of the valuable metal containing ore particles may be adhered to the gas bubbles and rise upwards with the continuous upwards flow of slurry, and at least part of the valuable metal containing ore particles may rise upwards with the continuous upwards flow of slurry. The valuable metal containing ore particles may be recovered by conducting the continuous upwards flow of slurry out of the at least one overflow flotation cell as slurry overflow. As the overflow cell may be operated with virtually no froth depth or froth layer, effectively no froth zone may be formed on the surface of the slurry at the top part of the flotation cell. The froth may be non-continuous over the cell. The outcome of this may be that more valuable mineral containing ore particles may be entrained into the concentrate stream, and the overall recovery of valuable material may be increased.

All of the flotation cells of a flotation line may be of a single type, that is, rougher flotation cells in the rougher part, scavenger flotation cells in the scavenger part, and scavenger cleaner flotation cells of the scavenger cleaner flotation line may be of one single flotation cell type so that the flotation arrangement comprises only one type of flotation cells as listed above. Alternatively, a number of flotation cells may be of one type while other cells are of one or more type so that the flotation line comprises two or more types of flotation cells as listed above.

Depending on its type, the flotation cell may comprise a mixer for agitating the slurry to keep it in suspension. By a mixer is herein meant any suitable means for agitating slurry within the flotation cell. The mixer may be a mechanical agitator. The mechanical agitator may comprise a rotor-stator with a motor and a drive shaft, the rotor-stator construction arranged at the bottom part of the flotation cell. The cell may have auxiliary agitators arranged higher up in the vertical direction of the cell, to ensure a sufficiently strong and continuous upwards flow of the slurry.

An “arrangement” of a cell configured to perform a process may refer to a set of parts of said cell suitable for or configured to perform at least one specific subprocess of said process. As such, a “cell comprising an arrangement” may refer to said cell comprising parts belonging to said arrangement. On the other hand, an arrangement for a cell may refer to a set of parts suitable for or configured to perform at least one specific subprocess. Generally, an arrangement for a cell may or may not form a part of said cell. Any arrangement may comprise any part(s), for example, mechanical, electrical, pneumatic, and/or hydraulic part(s), necessary and/or beneficial for performing its specific subprocess. Herein, a “part” may refer to an element or object, which is or may be assembled with one or more other elements or objects to form a device, an arrangement, or a cell.

Further, “slurry” may refer to a dispersion, comprising solid particles suspended in a continuous phase of flotation liquid. Consequently, a “slurry feeding arrangement” may refer to an arrangement of parts of a flotation cell or for said flotation cell suitable for or configured to feed slurry into a tank of said flotation cell. A slurry feeding arrangement may be suitable for or configured to feed slurry to a froth layer situated over a volume of slurry in a tank of a flotation cell.

Herein, slurry being “fed to a froth layer” may refer to feeding said slurry onto, and/or into, and/or immediately below, e.g., at most two times the froth depth, or at most the froth depth, or at most ½ of the froth depth, or at most 1/5 of the froth depth, or at most 1/10 of the froth depth below, said froth layer, and/or into the froth slurry interface. Additionally or alternatively, in embodiments, wherein a height of a launder lip defines a height of an upper surface of a froth layer, slurry being fed to said froth layer may refer to feeding said slurry into a tank at said launder lip height and/or at a position at most the froth depth, or at most ½ of the froth depth, or at most 1/5 of the froth depth, or at most 1/10 of the froth depth, or at most 1/50 of the froth depth below said launder lip height. Throughout this specification, froth flotation, wherein slurry is fed to a froth layer, may be referred to as “froth-interaction flotation”. Naturally, a “froth-interaction flotation cell” may then refer to a cell configured to or suitable for separation of material by froth-interaction flotation.

The flotation cell 1000 of an example of FIG. 1 may be configured to maintain a froth depth, of approximately 5 cm for the froth layer 1002. In other embodiments, wherein a slurry feeding arrangement is configured to feed slurry to a froth layer, any suitable substantially non-zero d^{f}, for example, a d^{f} in a range from 1 cm to 200 cm, may be used.

Herein, a “froth depth” may refer to a thickness of a froth layer in a tank. A froth depth may be measurable as a vertical distance between a launder lip and a surface of a volume of slurry in a tank, when said tank is in use.

Herein, a “tank” may refer to a receptacle suitable for or configured to hold a fluid, for example, a liquid. Further, a “volume of slurry” may refer to a certain amount of slurry.

The flotation cell 1000 of the example embodiment of FIG. 1 may be used in so-called “standard flotation”, wherein valuable mineral(s) in slurry is collected as overflow and gangue is directed to underflow. In other example embodiments, a flotation cell may be used in any suitable manner, for example, in standard flotation and/or in so-called “reverse flotation”, wherein valuable mineral(s) in slurry is directed to underflow and gangue is collected as overflow.

The flotation cell 1000 of the example embodiment of FIG. 1 may be configured for use in so-called “coarse flotation”, wherein slurry comprising a considerable amount of coarser solid particles is used as feed material for flotation. In other example embodiments, a flotation cell may or may not be configured for use in coarse flotation.

In the example embodiment of FIG. 1, the flotation cell 1000 comprises a tank 1100. In other embodiments, a flotation cell may or may not comprise a tank.

The tank 1100 of the embodiment of FIG. 1 is configured to hold a volume of slurry 1001 and a froth layer 1002 over the volume of slurry 1001. In other embodiments, a tank may or may not be configured in such manner.

According to an example embodiment, the flotation cell 1000 is a gravity feeding flotation cell.

By a gravity feeding flotation cell is meant a system, wherein a slurry may be fed into a flotation tank at a froth layer. This means that the slurry may be fed on top of the froth, into the froth and/or immediately below the froth. The fed slurry may first enter a dead bed chamber or a feed chamber prior to its entry into the main flotation tank. The feed chamber may be used to reduce slurry energy (velocity) and minimize wear on fixed parts. The feed chamber may operate at ambient or atmospheric pressure and may receive the slurry from at least one feeding means at ambient pressure. The feed chamber may act as an intermediate chamber that may dampen the slurry velocity and may allow gradual, evenly distributed overflow from the feed chamber over an overflow ramp into the main flotation tank.

The slurry feeding arrangement 1200 of the example embodiment of FIG. 1 is configured to feed slurry 1214 to the froth layer 1002. As such, the flotation cell 1000 is implemented as a froth-interaction flotation cell. Generally, feeding slurry to a froth layer may increase recovery of coarser mineral particles in said slurry. In other embodiments, a slurry feeding arrangement may be suitable for or configured to feed coarse slurry to a froth layer.

In the example embodiment of FIG. 1, the slurry feeding arrangement 1200 is arranged at a distance d from sidewalls 1004 of the tank 1100. In other embodiments, a slurry feeding arrangement may or may not be arranged at a distance d from sidewalls of a tank.

More specifically, in the example embodiment of FIG. 1, the slurry feeding arrangement 1200 is arranged centrally with respect to the tank 1100. In other embodiments, a slurry feeding arrangement may be arranged in any suitable manner, for example, centrally with respect to a tank.

According to an example embodiment, the feed chamber 1201 may be configured to operate in atmospheric pressure.

According to an example embodiment, the at least one gas bubble arrangement 1203 may be configured to feed gas bubbles 1204 into the feed chamber 1201 and/or on the overflow ramp 1205.

According to an example embodiment, the gas bubble arrangement 1203 may comprises one or more gas feed means 1206 configured to feed gas bubbles 1204 into the feed chamber 1201 and/or on the overflow ramp 1205.

An example of FIG. 2 shows a slurry feeding arrangement 1200 comprising a gas bubble arrangement 1203 configured to feed gas bubbles 1204 into a feed chamber 1201. The feed chamber 1201 may comprise a feed chamber bottom 1207, one or more feed chamber side walls 1208, and a top plate 1219. According to an example, two gas feed means 1206 are arranged on both sides of the slurry feed means 1202.

A gas bubble arrangement 1203 may comprise one or more gas feed means 1206 configured to feed gas bubbles 1204 into the feed chamber 1201. The one or more gas feed means 1206 may be arranged at least on one side of the one or more slurry feed means 1202 or around the one or more slurry feed means 1202.

A slurry feeding arrangement 1200 may further comprise an overflow ramp 1205 comprising a ramp bottom 1210, a ramp surface 1212, and a weir 1211. The gas bubbles 1204 may be added to the feed chamber 1201 separately from the feed slurry 1214. The particles and gas bubbles 1204 may contact each other in the feed chamber 1201. Gas may be introduced into the feed chamber 1201 by means of a sparger which may generate the gas bubbles 1204, which gas bubbles 1204 may then contact the slurry particles. The feed slurry 1214 may flows gently from the feed chamber 1201 over the overflow ramp 1205 and into the froth layer 1002 of a tank 1100. The overflow ramp 1205 may slope gently down from the feed chamber 1201 to a ramp bottom 1210, wherein a lowest point may locate, and then up to the weir 1211 over which the slurry 1214 may flow into the tank.

According to an example embodiment, the one or more gas feed means 1206 are configured to feed gas bubbles 1204 inside the feed chamber 1201 through the top plate 1219, feed chamber bottom 1207, and/or one or more feed chamber sides 1208. The one or more gas feed means 1206 may be configured to feed gas bubbles 1204 inside the feed chamber 1201 through the top plate 1219 to the feed chamber bottom 1207.

An example of FIGS. 3 and 4 shows a gas bubble arrangement 1203 configured to feed gas bubbles 1201 on an overflow ramp 1205. The feed slurry 1214 may flow from the feed chamber 1201 over the overflow ramp 1205 into a froth layer 1002 of a tank 1100. The overflow ramp 1205 may slope gently down from the feed chamber 1205 to a ramp bottom 1210 and then up to a weir 1211 over which the slurry 1214 may flow into the tank 1100. One or mor gas feed means 1206 or spargers may be arranged to feed gas bubbles 1204 on the overflow ramp 1205 that may extend transverse to the direction of slurry flow across the width of the overflow ramp 1205. The gas may be introduced into the feed slurry 1214 near the ramp bottom 1210 where it may mix with the slurry 1214 before it may enter the tank 1100.

According to an example embodiment, the gas bubble arrangement 1203 is configured to feed gas bubbles 1204 on the overflow ramp 1205, wherein the one or more gas feed means 1206 may be arranged to provide the gas bubbles 1204 over the width of the overflow ramp 1205 perpendicular to flow of the slurry 1214.

According to an example embodiment, the overflow ramp 1205 comprises a ramp bottom 1210, wherein the gas bubble arrangement 1203 is configured to feed gas bubbles 1204 on the overflow ramp 1205, wherein the one or more gas feed means 1206 are arranged. Each of the gas feed means 1206 may have a nozzle 1213 or outlet. The gas bubble arrangement may have one or more nozzles 1213 arranged in line over the width of the overflow ramp 1205 perpendicular to flow of the slurry 1214.

According to an example embodiment, each of the one or more gas feed means 1206 comprises one or more nozzles 1213.

According to an example embodiment, the overflow ramp 1205 comprises a ramp surface 1212, a ramp bottom, 1210 and a weir 1211. The ramp surface 1212 may be arranged outside and around the feed chamber 1201. The ramp surface 1213 may be configured to slope downwards and outwards from the top plate 1219 towards the froth layer 1002 and downwards the ramp bottom 1210, and to rise up from the ramp bottom 1210 towards the weir 1211.

According to an example embodiment, the feed chamber 1201 has an annular or circular shape. It may be arranged concentric to a tank side wall 1004 at a distance from a center axis 1221 of the flotation tank or to the center of the tank 1100.

Further, a “center axis” may refer to an imaginary line. A center axis may or may not extend through one or more center points, such as a center of mass and/or a centroid, of a tank. Additionally or alternatively, a center axis may or may not extend along a symmetry axis and/or a symmetry plane of a tank. The center axis may be a vertical line.

According to an example embodiment, the slurry feeding arrangement comprises 1 to 512 slurry feed means 1202. The slurry feeding arrangement may comprises 2 to 40 slurry feed means, preferably 4 to 24 slurry feed means. The slurry feed means may comprise one or more pipes or tubes.

According to an example embodiment, the one or more slurry feed means 1202 are arranged concentric to the tank side wall 1004 of the flotation cell 1000. They may be arranged at a distance from the center axis 1221 of the flotation tank or at the center of the tank 1100.

According to an example embodiment, the one or more slurry feed means 1201 are arranged above the froth layer 1002.

According to an example embodiment, the slurry feeding arrangement 1200 is configured to feed the slurry 1214 onto the froth layer 1002, into the froth layer 1002, into the froth slurry interface, and/or immediately below the froth layer 1002.

According to an example embodiment, the flotation cell 1000 further comprises a launder 1101 with a launder lip 1102 for collecting froth 1003 from the froth layer 1002.

According to an example embodiment, the flotation cell 1000 further comprises one or more froth crowders 1108 arranged to direct froth towards the launder 1101.

According to an example embodiment, when the flotation cell 1000 comprises froth crowder in the center of the tank the outer bottom surface 1228 of the froth crowder 1108 is configured to divert flotation gas and flotation liquid rising parallel to the center axel 1221 for forming a fluid stream 1109 surrounding the outer bottom surface 1228 of the froth crowder and to guide the fluid stream 1109 towards the launder lip 1102.

Generally, configuring an outer bottom surface of the froth crowder in such manner may facilitate maintaining a constant flow of the fed slurry and froth from a slurry feeding arrangement towards a launder lip, which may, in turn, increase recovery of valuable material containing particles. In other embodiments, an outer bottom surface of the froth crowder may or may not be configured to divert flotation gas and flotation liquid rising parallel to a center axel for forming a fluid stream surrounding said outer bottom surface and to guide said fluid stream towards a launder lip.

A froth crowder herein is meant a froth blocker, a froth baffle, or a crowding board, or a crowding board device, or any other such structure or side structure, for example a sidewall, inclined or vertical, having a crowding effect, i.e. a crowding sidewall, which can also be a crowding sidewall internal to the flotation tank, i.e. an internal perimeter crowder.

By utilizing a froth crowder, it may be possible to direct so-called “brittle froth”, i.e. a loosely textured froth layer comprising generally larger flotation gas bubbles agglomerated with the mineral ore particles intended for recovery, more efficiently and reliably towards the forth overflow lip and froth collection launder. A brittle froth can be easily broken, as the gas bubble-ore particle agglomerates are less stable and have a reduced tenacity. Such froth or forth layer cannot easily sustain the transportation of ore particles, and especially coarser particles, towards the froth overflow lip for collection into the launder, therefore resulting in particle drop-back to the slurry within the flotation cell or tank, and reduced recovery of the desired material. Brittle froth is typically associated with low mineralization, i.e. gas bubble-ore particle agglomerates with limited amount of ore particles comprising a desired mineral that have been able to attach onto the gas bubbles during the flotation process within a flotation cell or tank. The problem is especially pronounced in large-sized flotation cells or tanks with large volume and/or large diameter. With the invention at hand, it may be possible to crowd and direct the froth towards the froth overflow lip, to reduce the froth transportation distance (thereby reducing the risk of drop-back), and, at the same time, maintain or even reducing the overflow lip length. In other words, the handling and directing of the froth layer in a froth flotation cell or tank may become more efficient and straightforward.

It may also be possible to improve froth recovery and thereby valuable mineral particle recovery in large flotation cells or tanks from brittle froth specifically in the later stages of a flotation line, for example in the rougher and/or scavenger stages of a flotation process.

Further, with the invention described herein, the area of froth on the surface of the slurry inside a flotation tank may be decreased in a robust and simple mechanical manner. At the same time, the overall overflow lip length in a froth flotation cell may be decreased. Robust in this instance is to be taken to mean both structural simplicity and durability. By decreasing the froth surface area of a flotation cell by a froth crowder instead of adding extra froth collection launders, the froth flotation cell as a whole may be a simpler construction, for example because there is no need to lead the collected froth and/or overflow out of the added crowder. In contrast, from an extra launder, the collected overflow would have to be led out, which would increase the constructional parts of the flotation cell.

Especially in the downstream end of a flotation line, the amount of desired material that can be trapped into the froth within the slurry may be very low. In order to collect this material from the froth layer to the froth collection launders, the froth surface area should be decreased. By arranging a froth crowder into the flotation tank, the open froth surface between the forth overflow lips may be controlled. The crowder may be utilized to direct or guide the slurry within the flotation tank closer to a froth overflow lip of a froth collection launder, thereby enabling or casing froth formation very close to the froth overflow lip, which may increase the collection of valuable ore particles. The froth crowder may also influence the overall convergence of flotation gas bubbles and/or gas bubble-ore particle agglomerates into the froth layer. For example, if the gas bubbles and/or gas bubble-ore particle agglomerate flow becomes directed towards the center of a flotation tank, a froth crowder may be utilized to increase the froth area at the perimeter of the tank, and/or closer to any desired froth overflow lip. In addition, it may be possible to reduce the open froth surface in relation to the lip length, thereby improving the efficiency of recovery in the froth flotation cell.

According to an example embodiment, the flotation cell 1000 comprises a flotation gas supply arrangement 1300 for supplying flotation gas 1301 into the volume of slurry 1001 below the slurry feeding arrangement 1200.

The flotation gas supply arrangement 1300 may be configured to supply flotation gas 1301 into the volume of slurry 1001 such that the froth layer 1002 may be maintained over the volume of slurry 1001. In other example embodiments, a flotation gas supply arrangement may or may not be configured in such manner.

The flotation gas supply arrangement 1300 may be configured to supply flotation gas 1301 into the volume of slurry 1001 below the slurry feeding arrangement 1200. Generally, a flotation gas supply arrangement being configured in such manner may enable directing flotation gas bubbles rising in a volume of slurry onto an outer bottom surface of a lower part of a slurry feeding arrangement and/or increase the probability of recollection of valuable material containing particles into a froth layer following drop-off. In other embodiments, a flotation gas supply arrangement may or may not be configured in such manner.

The flotation gas supply arrangement 1300 may be configured to supply flotation gas 1301 into the volume of slurry 1001 below the slurry feeding arrangement 1200 by feeding flotation gas 1301 into the volume of slurry 1001 via a flotation gas inlet. In other example embodiments, wherein flotation gas supply arrangement is configured to supply flotation gas into a volume of slurry 1001 below a slurry feeding arrangement, said flotation gas supply arrangement may be configured to supply said flotation gas below said slurry feeding arrangement in any suitable manner(s), for example, by feeding flotation gas into a volume of slurry via a flotation gas inlet.

Throughout this specification, an “inlet” may refer to a means of entry, e.g., an opening or a through-hole, for a fluid. Generally, an inlet may be arranged in a tank in any suitable manner, for example, at a side wall or at a bottom of a tank, or at an end of a pipe or other suitable conduit for passing fluid through a side wall or a bottom of a tank, or at an end of a pipe or other suitable conduit for passing fluid over a side wall of a tank.

In this specification, a “flotation gas inlet” may refer to an inlet configured to or suitable for passing flotation gas into a tank.

The flotation gas inlet may be arranged below the slurry feeding arrangement 1200. In other embodiments, a flotation gas inlet and a slurry feeding arrangement may be arranged in any suitable manner, for example, such that said flotation gas inlet is arranged below said slurry feeding arrangement.

The tank 1100 may comprise a flotation liquid inlet. In other embodiments, a tank may or may not comprise such flotation liquid inlet.

Herein, a “flotation liquid inlet” may refer to an inlet configured to or suitable for passing flotation liquid into a tank.

The flotation liquid inlet of the embodiment is arranged below the slurry feeding arrangement 1200. In other embodiments, a flotation liquid inlet may be arranged in any suitable manner, for example, below a slurry feeding arrangement.

According to an example embodiment, the flotation cell 1000 comprises a flotation liquid supply arrangement configured to supply flotation liquid into the volume of slurry 1001 below the slurry feeding arrangement 1200. A flotation liquid supply arrangement being configured in such manner may generally facilitate maintaining an upwardly directed flow, which may, facilitate directing slurry discharged via a gap towards lateral directions of a lower part and/or increase the probability of recollection of valuable material containing particles into a froth layer following drop-off.

The tank 1100 of the example embodiment of FIG. 1 comprises an underflow outlet 1104 for discharging underflow 1105 from the volume of slurry 1001.

Throughout this specification, “underflow” may refer to coarse slurry, comprising solid particles of larger diameters. As known to the skilled person, the definition of coarse slurry may be application-specific and/or ore-specific. For example, in some embodiments, coarse slurry may refer to slurry, having a particle-size distribution with a percent passing less than 80% at a sieve size of 3000 μm, or at a sieve size of 425 μm, or at a sieve size of 355 μm, or at a sieve size of 250 μm, or at a sieve size of 180 μm, or at a sieve size of 150 μm, or at a sieve size of 125 μm, or at a sieve size of 105 μm.

On the other hand, an “outlet” may refer to a means of discharge, e.g., an opening or a through-hole, for a fluid. Generally, an outlet may be arranged in a tank in any suitable manner, for example, at a side wall or at a bottom of a tank, or at an end of a pipe or other suitable conduit for passing fluid through a side wall or a bottom of a tank, or at an end of a pipe or other suitable conduit for passing fluid over a side wall of a tank.

Consequently, a “underflow outlet” may refer to an outlet configured to or suitable for passing coarse slurry out of a tank. An underflow outlet may additionally be configured to or suitable for passing any other suitable type(s) of slurry out of a tank. Typically, an underflow outlet is arranged at a lower section of a tank for collecting a flotation product from said tank.

The tank may comprise a downwardly tapering bottom cone. Generally, a tank comprising a bottom cone may reduce sanding in said tank. In other embodiments, a tank may or may not comprise such bottom cone.

Throughout this specification, a “bottom cone” of a tank may refer to a generally funnel-shaped and downwardly tapering bottom structure of said tank suitable for or configured to guide settled solid particles towards an outlet or an inlet.

The tank may comprise a flat bottom; a side wall, extending from said bottom; and an underflow outlet arranged at said side wall.

Above, mainly structural aspects of flotation cells have been discussed. In the following, more emphasis will lie on aspects related to flotation methods. What is said above about the ways of implementation, definitions, details, and advantages related to flotation cells apply, mutatis mutandis, to the methods discussed below. The same applies vice versa.

It is specifically to be understood that any flotation method according to this specification may be used to operate a flotation cell according to this specification. Correspondingly, any flotation cell according to this specification may be operated in accordance with a method according to this specification.

FIG. 7 illustrates an example of a method for treating particles suspended in slurry 1214 in a flotation cell 1000.

At operation 100, the method may comprise providing a tank 1100 for holding a volume of slurry 1001 and a froth layer 1002 over the volume of the slurry 1001.

At operation 110, the method may comprise feeding, by a slurry feeding arrangement 1200 comprising one or more slurry feed means 1202, the slurry 1214 to a feed chamber 1201.

At operation 120, the method may comprise receiving, by the feed chamber 1201, the slurry 1214 from the one or more slurry feed means 1202.

At operation 130, the method may comprise leading 130 the fed slurry 1214, by an overflow ramp 1205 between the feed chamber 1201 and the tank 1100, from the feed chamber 1201 to the froth layer 1002.

At operation 140, the method may comprise feeding gas bubbles 1204, by one or more gas bubble arrangements 1203, to the fed slurry 1214 before the fed slurry 1214 enters to the froth layer 1002.

It is obvious to a person skilled in the art that with the advancement of technology, the basic idea of the invention may be implemented in various ways. The invention and its embodiments are thus not limited to the examples described above, instead they may vary within the scope of the claims.

It will be understood that any benefits and advantages described above may relate to one embodiment or may relate to several embodiments. The embodiments are not limited to those that solve any or all of the stated problems or those that have any or all of the stated benefits and advantages.

The term “comprising” is used in this specification to mean including the feature(s) or act(s) followed thereafter, without excluding the presence of one or more additional features or acts. It will further be understood that reference to ‘an’ item refers to one or more of those items.

### REFERENCE SIGNS

d^{f} froth depth, thickness of the froth layer
d^{b} distance between the gas bubble arrangement and the lower edge of the overflow ramp
d distance between the slurry feeding arrangement and the tank side wall
1000 flotation cell
1001 volume of slurry
1002 froth layer
1003 overflow
1004 tank side wall
1100 tank
1101 launder
1102 launder lip
1103 bottom cone
1104 underflow outlet
1105 underflow
1108 froth crowder
1109 fluid stream
1200 slurry feeding arrangement
1201 feed chamber
1202 slurry feed means
1203 gas bubble arrangement
1204 gas bubbles
1205 overflow ramp
1206 gas feed means
1207 feed chamber bottom
1208 feed chamber side wall
1210 ramp bottom
1211 weir
1212 ramp surface
1213 nozzle
1214 slurry
1215 feed means connector
1216 slurry overflow lip
1217 compartments
1218 partition wall
1219 top plate
1220 feed opening
1221 center axis
1222 feeding strip
1223 lower edge
1224 upper edge
1225 second end
1226 guiding plate
1228 outer bottom surface
1300 flotation gas supply arrangement
1301 flotation gas

1. A slurry feeding arrangement configured to feed slurry to a froth layer, the slurry feeding arrangement comprising
one or more slurry feed means configured to feed the slurry;
a feed chamber configured to receive the fed slurry from the one or more slurry feed means; and
an overflow ramp between the feed chamber and the froth layer configured to lead the fed slurry from the feed chamber to the froth layer.

2. The slurry feeding arrangement according to claim 1, comprising a feed means connector connectable to the one or more slurry feed means, wherein the feed chamber is placed under the feed connector and arranged to receive the fed slurry from the one or more slurry feed means.

3. The slurry feeding arrangement according to claim 2, wherein the feed means connector comprises a top plate having one or more feed openings, through which the fed slurry is arranged to enter the feed chamber and/or compartments.

4. The slurry feeding arrangement according to claim 1, wherein the feed chamber comprises a feed chamber bottom and a slurry overflow lip located above the feed chamber bottom; and an overflow ramp extending obliquely downwards from the slurry overflow lip, wherein the fed slurry is configured to flow from the feed chamber over the slurry overflow lip onto the overflow ramp during operation of the slurry feeding arrangement.

5. The slurry feeding arrangement according to claim 4, wherein the feed chamber is ring-shaped, and the slurry overflow lip is arranged on the perimeter of the feed chamber.

6. The slurry feeding arrangement according to claim 1, wherein the feed chamber is divided into one or more separate compartments by one or more partition walls.

7. The slurry feeding arrangement according to claim 1, wherein the overflow ramp is arranged at an angle of 10 to 60 degrees to the horizontal.

8. The slurry feeding arrangement according to claim 1, wherein the slurry overflow lip is ring-shaped, and the overflow ramp encircles the slurry overflow lip.

9. The slurry feeding arrangement according to claim 1, wherein the slurry feeding arrangement comprises feeding strips extending from the lower edge of the overflow ramp and arranged at a distance from each other in the direction of the lower edge.

10. The slurry feeding arrangement according to claim 9, wherein the ends of the feeding strips are connected to a lower edge of the overflow ramp, and the feeding strips taper towards their second ends.

11. The slurry feeding arrangement according to claim 9, wherein the feeding strips are triangular in shape.

12. The slurry feeding arrangement according to claim 1, wherein the slurry feeding arrangement comprise one or more downward sloping guiding plates placed under the lower edge of the overflow ramp and/or the feeding strips.

13. The slurry feeding arrangement according to claim 1, wherein the one or more slurry feed means are configured to feed the slurry by gravity.

14. The slurry feeding arrangement according to claim 1, wherein the feed chamber is configured to operate in atmospheric pressure.

15. The slurry feeding arrangement according to claim 1, wherein the slurry feeding arrangement further comprises at least one gas bubble arrangement configured to feed gas bubbles into the feed chamber and/or on the overflow ramp.

16. The slurry feeding arrangement according to claim 15, wherein the at least one gas bubble arrangement comprises one or more gas feed means configured to feed the gas bubbles into the feed chamber and/or on the overflow ramp.

17. The slurry feeding arrangement according to claim 16, wherein the one or more gas feed means are configured to feed gas bubbles inside the feed chamber (through the top plate, feed chamber bottom, and/or one or more feed chamber sidewalls.

18. The slurry feeding arrangement according to claim 15, wherein the at least one gas bubble arrangement is configured to feed the gas bubbles on the overflow ramp, wherein the one or more gas feed means are arranged to provide the gas bubbles over the width of the overflow ramp perpendicular to flow of the slurry.

19. The slurry feeding arrangement according to claim 15, wherein the overflow ramp comprises a ramp bottom, wherein the gas bubble arrangement is configured to feed gas bubbles on the overflow ramp at a distance from the lower edge of the overflow ramp.

20. The slurry feeding arrangement according to claim 19, wherein the ramp bottom has at least one of the following form: a curved, stepped, and/or corrugated.

21. The slurry feeding arrangement according to claim 16, wherein each of the one or more gas feed means comprises one or more nozzles or outlets.

22. The slurry feeding arrangement according to claim 1, wherein the overflow ramp comprises a ramp surface, a ramp bottom and a weir, wherein the ramp surface is
arranged towards the froth layer;
configured to slope towards the froth layer and downwards towards the ramp bottom; and
configured to rise up from the ramp bottom towards the weir.

23. The slurry feeding arrangement according to claim 1, wherein the slurry feeding arrangement comprises 1 to 512 slurry feed means.

24. A flotation cell for treating particles suspended in slurry, wherein the flotation cell comprising
a tank for holding a volume of slurry and a froth layer over the volume of slurry; and
a slurry feeding arrangement according to claim 1.

25. The flotation cell according to claim 24, wherein the feed chamber has an annular or circular shape, and it is arranged concentric to a tank side wall.

26. The flotation cell according to claim 24, wherein the one or more slurry feed means are arranged concentric to the tank side wall of the flotation cell.

27. The flotation cell according to claim 24, wherein the one or more slurry feed means are arranged above the froth layer.

28. The flotation cell according to claim 24, wherein the slurry feeding arrangement (is configured to feed the slurry onto the froth layer, into the froth layer, into the froth slurry interface, and/or immediately below the froth layer.

29. The flotation cell according to claim 24, wherein the flotation cell further comprises a launder with a launder lip for collecting froth from the froth layer.

30. The flotation cell according to claim 24, wherein the flotation cell further comprises one or more froth crowders arranged to direct froth towards a launder.

31. A flotation cell according to claim 24, wherein the flotation cell comprises a flotation gas supply arrangement for supplying flotation gas into the volume of slurry below the slurry feeding arrangement.

32. A method for treating particles suspended in slurry in a flotation cell according to claim 24, the method comprising
providing a tank for holding a volume of the slurry and a froth layer over the volume of the slurry;
feeding, by a slurry feeding arrangement comprising one or more slurry feed means, the slurry to a feed chamber;
receiving, by the feed chamber, the fed slurry from the one or more slurry feed means; leading the fed slurry, by an overflow ramp between the feed chamber and the tank, from the feed chamber to the froth layer; and
feeding gas bubbles, by one or more gas bubble arrangements, to the fed slurry before the fed slurry enters to the froth layer.
